(19) United States
(12) Patent Application Publication
(10) Pub. No.: US 2025/0055139 A1
(43) Pub. Date: Feb. 13, 2025

(54) BATTERY MODULE

(71) Applicant: Prime Planet Energy & Solutions, Inc., Tokyo (JP)

(72) Inventor: Tetsuji OMURA, Kobe-shi (JP)

(21) Appl. No.: 18/754,164

(22) Filed: Jun. 26, 2024

(30) Foreign Application Priority Data
Aug. 8, 2023 (JP) 2023-129173

(51) Int. Cl. H01M 50/477; H01M 10/658; H01M 50/48

(52) U.S. Cl. CPC H01M 50/477; H01M 10/658; H01M 50/48

(57) ABSTRACT

A plurality of battery cells are arranged side by side in a first direction. A separator is located between the plurality of battery cells. The separator includes an elastic body that is elastically deformable at least in the first direction. The elastic body has a first portion. The first portion has a frame shape that extends around an axis in the first direction and that defines a closed space inside the first portion. In the first direction, a thickness of the first portion in a no-load state is 1.30 times or more and 2.87 times or less as large as a thickness of the first portion in a state in which the first portion is disposed between the plurality of battery cells and elastically deformed in a compression direction.

### CROSS REFERENCE TO RELATED APPLICATIONS

This nonprovisional application is based on Japanese Patent Application No. 2023-129173 filed on Aug. 8, 2023 with the Japan Patent Office, the entire contents of which are hereby incorporated by reference.

### BACKGROUND OF THE INVENTION

### Field of the Invention

The present technology relates to a battery module.

### Description of the Background Art

Japanese Patent Laying-Open No. 2020-4556 is a prior art document that discloses a configuration of a cushioning sheet for a battery module. The cushioning sheet for a battery module as described in Japanese Patent Laying-Open No. 2020-4556 includes: a base portion having a plate shape; and an elastic protrusion. The elastic protrusion is formed to protrude from the base portion toward a target surface of the battery cell. The elastic protrusion elastically supports a battery cell when the battery cell is expanded to have a curved shape due to charging of the battery cell, and applies reaction force to the battery cell when the battery cell is contracted due to discharging of the battery cell.

Japanese Patent Laying-Open No. 2010-238554 is a prior art document that discloses a configuration of a holder for a power storage element. The holder described in Japanese Patent Laying-Open No. 2010-238554 supports a plurality of power storage elements. The holder includes an elastic body and an injection portion. The elastic body includes a hollow portion in a closed state. Via the injection portion, gas is injected into the hollow portion. In response to an increase in pressure in the hollow portion, pressure is applied to the power storage element.

### SUMMARY OF THE INVENTION

In the cushioning sheet for a battery module as disclosed in Japanese Patent Laying-Open No. 2020-4556, as the elastic protrusion is elastically deformed, a load for elastically deforming the elastic protrusion is increased. Thus, the elastic protrusion cannot be sufficiently elastically deformed, with the result that the reaction force of the separator against the expansion of the battery cell may be decreased.

In the holder for a power storage element as described in Japanese Patent Laying-Open No. 2010-238554, the pressure in the hollow portion is adjusted by the injection portion, thus resulting in a complicated configuration thereof.

The present technology has been made to solve the above-described problem, and has an object to provide a battery module to suppress, with a simple configuration, a decrease in reaction force of a separator against expansion of a battery cell.

The present technology provides the following battery module.
[1]

A battery module comprising:
a plurality of battery cells arranged side by side in a first direction; and
a separator located between the plurality of battery cells, wherein
the separator includes an elastic body that is elastically deformable at least in the first direction,
the elastic body has a first portion having a frame shape that extends around an axis in the first direction and that defines a closed space inside the first portion, and
in the first direction, a thickness of the first portion in a no-load state is 1.30 times or more and 2.87 times or less as large as a thickness of the first portion in a state in which the first portion is disposed between the plurality of battery cells and is elastically deformed in a compression direction.
[2]

The battery module according to [1], wherein
at a first abutment surface of the first portion, the first portion is in abutment with at least one battery cell of the plurality of battery cells in the first direction, and
the first abutment surface has a protruding-recessed shape.
[3]

The battery module according to [2], wherein
at the first abutment surface, the first portion is in abutment with one battery cell of two battery cells between which the separator is sandwiched among the plurality of battery cells, and
in the first direction, a width of the first portion becomes narrower in a direction from the other battery cell of the two battery cells toward the one battery cell of the two battery cells.
[4]

The battery module according to any one of [1] to [3], wherein the elastic body further has a connection portion that is located at an end portion of the first portion in the first direction and that connects peripheral edges of the frame shape of the first portion.
[5]

The battery module according to any one of [1] to [4], wherein
the elastic body further has a second portion that is located on an outer side with respect to the first portion when viewed in the first direction and that has a frame shape extending around the axis in the first direction,
at a second abutment surface of the second portion, the second portion is in abutment with at least one battery cell of the plurality of battery cells in the first direction, and
in the first direction, a thickness of the second portion in a state in which the second portion is in abutment with the at least one battery cell is substantially the same as the thickness of the first portion in the state in which the first portion is disposed between the plurality of battery cells and is elastically deformed in the compression direction.
[6]

The battery module according to [5], wherein a clearance is formed between the first portion and the second portion in a direction orthogonal to the first direction.
[7]

The battery module according to [1], wherein
the elastic body further has a second portion that is located on an outer side with respect to the first portion when viewed in the first direction and that has a frame shape extending around the axis in the first direction,
at a first abutment surface of the first portion, the first portion is in abutment with at least one battery cell of the plurality of battery cells in the first direction,
at a second abutment surface of the second portion, the second portion is in abutment with the at least one battery cell in the first direction,
at an end portion of the first portion opposite to a side on which the first abutment surface is located in the first direction, the first portion has a first width of a portion of the frame shape of the first portion in a direction orthogonal to the first direction,
at an end portion of the second portion opposite to a side on which the second abutment surface is located in the first direction, the second portion has a second width of a portion of the frame shape of the second portion in the direction orthogonal to the first direction, and
the second width is wider than the first width.
[8]

The battery module according to [1], wherein
the elastic body further has a second portion that is located on an outer side with respect to the first portion when viewed in the first direction and that has a frame shape extending around the axis in the first direction,
at a first abutment surface of the first portion, the first portion is in abutment with one battery cell of two battery cells between which the separator is sandwiched among the plurality of battery cells, and
the first portion has a tapered surface that faces the second portion and that is inclined, in a direction from the other battery cell of the plurality of battery cells toward the one battery cell of the plurality of battery cells, from the outer side toward an inner side around the axis in the first direction in the no-load state.
[9]

The battery module according to any one of [1] to [8], wherein the separator further includes a heat insulating material disposed in the closed space and having an inner space.
[10]

The battery module according to any one of [1] to [9], further comprising an adhesive agent layer that adheres the elastic body and the plurality of battery cells in the first direction.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a configuration of a battery module according to a first embodiment of the present technology.

FIG. 2 is a perspective view showing an internal configuration of the battery module according to the first embodiment of the present technology.

FIG. 3 is a perspective view showing a configuration of each battery cell included in the battery module according to the first embodiment of the present technology.

FIG. 4 is a cross sectional view of the battery module of FIG. 2 when viewed in a direction of arrow of a line IV-IV.

FIG. 5 is a cross sectional view of the battery module of FIG. 2 when viewed in a direction of arrow of a line V-V.

FIG. 6 is a cross sectional view showing a state in which no load is applied to a separator included in the battery module according to the first embodiment of the present technology.

FIG. 7 is a cross sectional view showing a state in which pressure from a closed space of the separator is applied to the battery cell included in the battery module according to the first embodiment of the present technology when the battery cell is expanded.

FIG. 8 is a cross sectional view showing a load required to support, by the separator, the battery cell included in the battery module according to the first embodiment of the present technology.

FIG. 9 is a graph showing a relation between the load and a ratio of a thickness of the separator after compressive deformation to a thickness of the separator before the compressive deformation in the battery module according to each of the first embodiment and a comparative example.

FIG. 10 is a cross sectional view showing a configuration of a battery module according to a second embodiment of the present technology.

FIG. 11 is a cross sectional view showing a configuration of a battery module according to a third embodiment of the present technology.

FIG. 12 is a cross sectional view showing a configuration of a battery module according to a fourth embodiment of the present technology.

FIG. 13 is a cross sectional view showing a configuration of a battery module according to a fifth embodiment of the present technology.

FIG. 14 is a cross sectional view showing a configuration of a battery module according to a sixth embodiment of the present technology.

FIG. 15 is a cross sectional view showing a configuration of a battery module according to a seventh embodiment of the present technology.

FIG. 16 is a cross sectional view showing a configuration of a battery module according to an eighth embodiment of the present technology.

FIG. 17 is a cross sectional view showing a configuration of a battery module according to a ninth embodiment of the present technology when a separator is in a no-load state.

FIG. 18 is a cross sectional view of the battery module of FIG. 17 when viewed in a direction of arrows of a line XVIII-XVIII.

FIG. 19 is a cross sectional view showing a configuration of the battery module according to the ninth embodiment of the present technology in a state in which the separator is compressed and deformed.

FIG. 20 is a cross sectional view showing a configuration of a battery module according to a tenth embodiment of the present technology when a separator is in a no-load state.

FIG. 21 is a cross sectional view showing a configuration of the battery module according to the tenth embodiment of the present technology in a state in which the separator is compressed and deformed.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “battery” is not limited to a lithium ion battery, and may include other batteries such as a nickel-metal hydride battery and a sodium-ion battery. In the present specification, the term “electrode” may collectively represents a positive electrode and a negative electrode.

Further, the “battery module” can be mounted on vehicles such as a hybrid electric vehicle (HEV), a plug-in hybrid electric vehicle (PHEV), and a battery electric vehicle (BEV). It should be noted that the use of the “battery module” is not limited to the use in a vehicle.

It should be noted that in each of the figures, an X direction serving as a second direction is defined as a direction in which a positive electrode terminal and a negative electrode terminal of a battery cell are arranged, a Y direction serving as a first direction is defined as a direction in which a plurality of battery cells are arranged, and a Z direction serving as a third direction is defined as a direction in which upper surface and lower surface of the battery cell are arranged. Further, in order to facilitate understanding of the present technology, the size of each configuration in the figures may be changed from the actual size thereof.

### First Embodiment

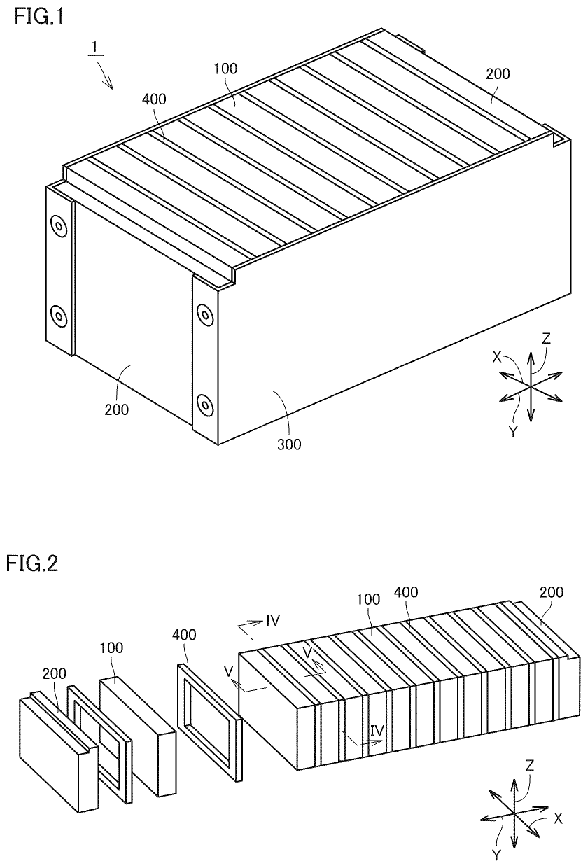

First, a configuration of a battery module according to a first embodiment of the present technology will be described. FIG. 1 is a perspective view showing the configuration of the battery module according to the first embodiment of the present technology. FIG. 2 is a perspective view showing an internal configuration of the battery module according to the first embodiment of the present technology.

As shown in FIGS. 1 and 2, battery module 1 according to the first embodiment of the present technology includes battery cells 100, end plates 200, restraint members 300, and separators 400.

The plurality of battery cells 100 are arranged side by side in the first direction (Y direction). Each separator 400 described below is disposed between battery cells 100. The plurality of battery cells 100, which are sandwiched between two end plates 200, are pressed by end plates 200 with separators 400 being interposed therebetween, and are therefore restrained between two end plates 200.

End plates 200 are provided at both ends of the plurality of battery cells 100 in the first direction (Y direction). Each of end plates 200 is fixed to a base such as a housing that accommodates battery module 1. End plate 200 is composed of, for example, aluminum or iron.

As shown in FIG. 1, restraint members 300 are provided at both ends of the plurality of battery cells 100 and end plates 200 in the X direction. When each of restraint members 300 is engaged with end plates 200 with compressive force in the Y direction being applied to the plurality of stacked battery cells 100 and end plates 200 and then the compressive force is released, tensile force acts on restraint member 300 that connects two end plates 200. As a reaction thereto, restraint member 300 presses two end plates 200 in directions of bringing them closer to each other. As a result, restraint member 300 restrains the plurality of battery cells 100 in the Y direction.

Separators 400 are disposed between the plurality of battery cells 100. Further, a separator 400 is disposed between end plate 200 and battery cell 100 located at an end portion in the Y direction and included in the plurality of battery cells 100. Separators 400 are in abutment with the long side surfaces of the plurality of battery cells 100 or the long side surfaces of end plates 200.

Each of separators 400 has an insulating property. Thus, separator 400 insulates the plurality of battery cells 100 from one another or insulates the battery cells 100 from end plates 200. Details of separator 400 will be described later.

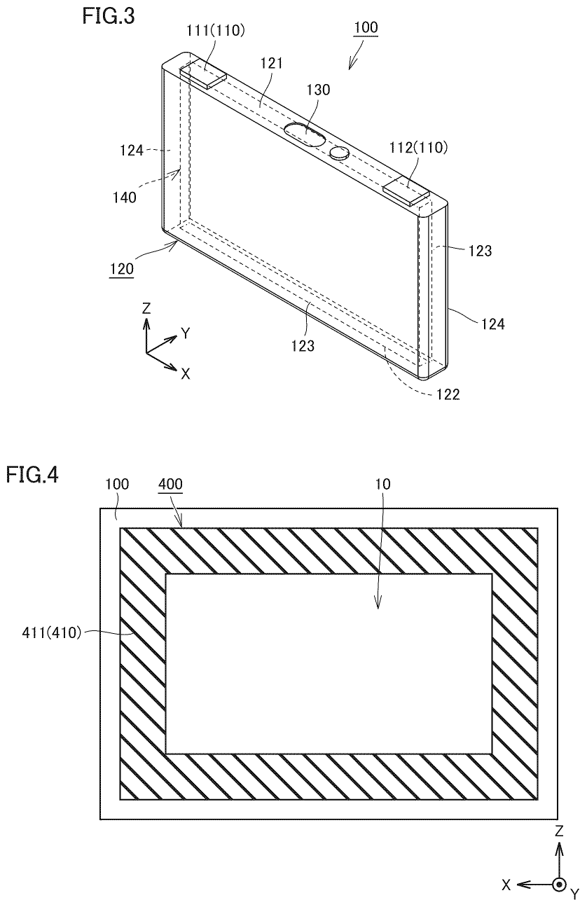

FIG. 3 is a perspective view showing a configuration of each battery cell included in the battery module according to the first embodiment of the present technology.

As shown in FIG. 3, battery cell 100 includes electrode terminals 110, a case 120, a gas-discharge valve 130, and an electrode assembly 140.

Electrode terminals 110 are formed on case 120. Electrode terminals 110 have a positive electrode terminal 111 and a negative electrode terminal 112. Positive electrode terminal 111 and negative electrode terminal 112 are arranged side by side in the second direction (X direction).

Case 120 is a container that accommodates electrode assembly 140 and an electrolyte solution. Case 120 has a substantially rectangular parallelepiped shape. Case 120 is composed of aluminum, an aluminum alloy, iron, an iron alloy, or the like.

Case 120 has an upper surface 121, a lower surface 122, a pair of long side surfaces 123, and a pair of short side surfaces 124.

Electrode terminals 110 are disposed on upper surface 121. Lower surface 122 is opposite to upper surface 121 in the third direction (Z direction).

The pair of long side surfaces 123 and the pair of short side surfaces 124 constitute side surfaces of case 120. The pair of long side surfaces 123 and the pair of short side surfaces 124 serving as the side surfaces of case 120 intersect each of upper surface 121 and lower surface 122. The pair of long side surfaces 123 are opposite to each other in the first direction (Y direction) with electrode assembly 140 being interposed therebetween. The pair of short side surfaces 124 are opposite to each other in the second direction (X direction) with electrode assembly 140 being interposed therebetween. Each of the pair of long side surfaces 123 has a larger area than that of each of the pair of short side surfaces 124.

Gas-discharge valve 130 is fractured when pressure inside case 120 becomes equal to or more than a predetermined value. Thus, gas in case 120 is discharged to outside of case 120.

Electrode assembly 140 functions as a power generation element. Electrode assembly 140 includes a positive electrode and a negative electrode (not shown). A substrate of the positive electrode is, for example, an aluminum alloy foil. A substrate of the negative electrode is, for example, a copper alloy foil. Electrode assembly 140 is, for example, a wound type electrode assembly in which the positive electrode and the negative electrode are wound or a stacked type electrode assembly in which the positive electrode and the negative electrode are alternately stacked.

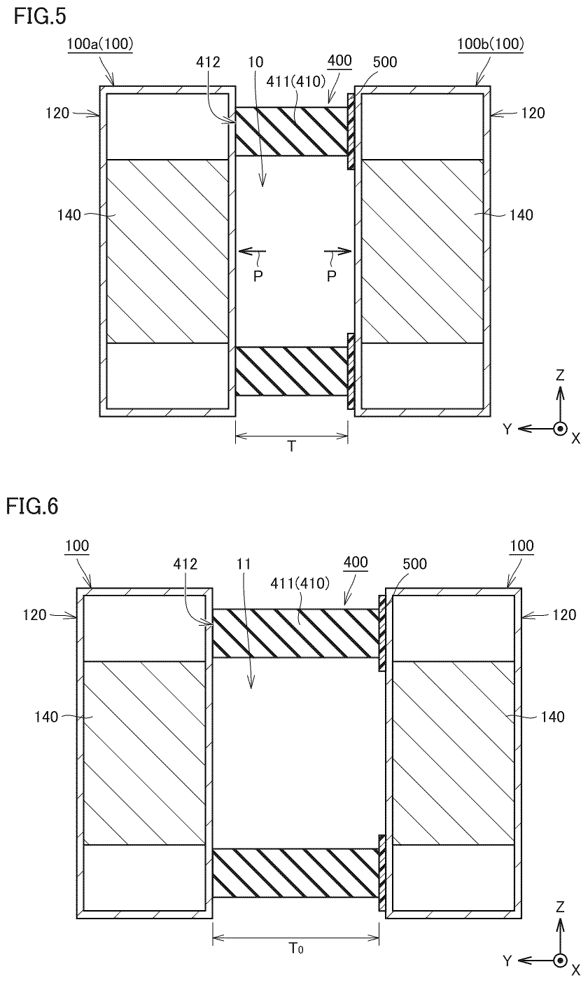

FIG. 4 is a cross sectional view of the battery module of FIG. 2 when viewed in a direction of arrow of a line IV-IV. FIG. 5 is a cross sectional view of the battery module of FIG. 2 when viewed in a direction of arrow of a line V-V.

As shown in FIGS. 4 and 5, separator 400 according to the present embodiment includes an elastic body 410. Battery module 1 according to the present embodiment further includes an adhesive agent layer 500.

Elastic body 410 is elastically deformable at least in the first direction (Y direction). Elastic body 410 in the present embodiment is elastically deformable in all the directions including the first direction (Y direction), the second direction (X direction), and the third direction (Z direction).

Elastic body 410 can be composed of, for example, a material having electrical insulation property and elasticity, such as a silicone rubber, a fluororubber, a urethane rubber, a natural rubber, a styrene-butadiene rubber, a butyl rubber, an ethylene propylene rubber (EPM or EPDM), a butadiene rubber, an isoprene rubber, a norbornene rubber, or the like.

Elastic body 410 has a first portion 411 having a frame shape that extends around an axis in the first direction (Y direction). It should be noted that first portion 411 in the present embodiment is constituted of one member, but is not limited to this configuration. First portion 411 may be constituted of two or more members. When first portion 411 is constituted of two or more members, the members are joined to each other by adhesion or the like.

At a first abutment surface 412 of first portion 411, first portion 411 is in abutment with at least one battery cell 100 of the plurality of battery cells 100 in the first direction (Y direction). In the present embodiment, at first abutment surface 412, first portion 411 is in abutment with one battery cell 100a of two battery cells between which separator 400 is sandwiched among the plurality of battery cells 100.

Adhesive agent layer 500 adheres elastic body 410 and each of the plurality of battery cells 100 in the first direction (Y direction). In the present embodiment, at an end portion of first portion 411 opposite to the side on which first abutment surface 412 is located in the first direction (Y direction), adhesive agent layer 500 adheres first portion 411 and the other battery cell 100b of the two battery cells between which separator 400 is sandwiched. It should be noted that adhesive agent layer 500 may not necessarily be provided in battery module 1.

In the first direction (Y direction), first portion 411 is sandwiched between the plurality of battery cells 100 and is elastically deformed in the compression direction. First portion 411 that is elastically deformed in the compression direction has a thickness T.

Thickness T of first portion 411 can be calculated, for example, by subtracting the thicknesses of end plates 200 and the thicknesses of the plurality of battery cells 100 from the entire length of battery module 1 in the first direction (Y direction) and dividing the resulting numerical value by the number of separators 400.

First portion 411 defines a closed space 10 inside first portion 411. The expression “defines a closed space 10” includes: forming closed space 10 only by elastic body 410; and forming closed space 10 by elastic body 410 and another member. The other member may be battery cell 100 or another member having elasticity.

Closed space 10 in the present embodiment is formed to be surrounded by two battery cells 100 of the plurality of battery cells 100 in the first direction (Y direction) and surrounded by first portion 411 around the axis in the first direction (Y direction).

FIG. 6 is a cross sectional view showing a state in which no load is applied to the separator included in the battery module according to the first embodiment of the present technology.

As shown in FIG. 6, before the respective constituent members of battery module 1 are assembled, separator 400 is in a no-load state in which separator 400 is not pressed from battery cell 100. First portion 411 of separator 400 in the no-load state has a thickness To in the first direction (Y direction).

When first portion 411 is changed from the no-load state so as to be sandwiched between battery cells 100 and is accordingly pressed, first portion 411 is elastically deformed in the compression direction. Thus, as shown in FIGS. 5 and 6, first portion 411 is elastically deformed such that thickness To of first portion 411 becomes thickness T.

When first portion 411 is elastically deformed such that thickness To of first portion 411 becomes thickness T, closed space 11 of first portion 411 in the no-load state is compressed. Hence, pressure in closed space 10 thus compressed is increased as compared with that in closed space 11 in the no-load state. Pressure P of closed space 10 is applied to battery cells 100.

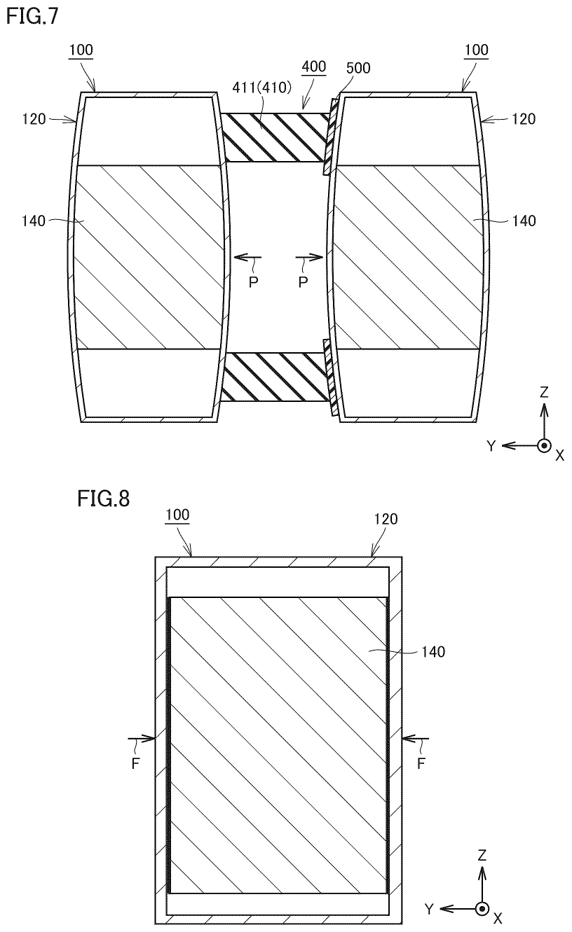

FIG. 7 is a cross sectional view showing a state in which pressure from the closed space of the separator is applied to the battery cell included in the battery module according to the first embodiment of the present technology when the battery cell is expanded.

As shown in FIG. 7, battery cell 100 may be expanded due to charging of battery module 1 or the like. In this case, pressure P in closed space 10 of first portion 411 serves as reaction force against the expansion of battery cell 100. Therefore, it is required to set an appropriate pressure P against the expansion of battery cell 100.

Pressure P of closed space 10 can be adjusted in accordance with a degree of volume change of closed space 10 before and after the compression deformation. In the present embodiment, pressure P of closed space 10 is set by adjusting a ratio (T₀/T) of the thicknesses of first portion 411 before and after the compression deformation with regard to the volume change of closed space 10.

FIG. 8 is a cross sectional view showing a load required to support, by the separator, the battery cell included in the battery module according to the first embodiment of the present technology.

If no load for restraining battery cell 100 is applied, when battery cell 100 is vibrated, the position of electrode assembly 140 is displaced inside case 120, with the result that electrode assembly 140 may be damaged. In order to avoid this, as shown in FIG. 8, it is necessary to apply load F for restraining battery cell 100 so as to prevent the electrode from being displaced due to friction between case 120 and electrode assembly 140 during the vibration. The ratio (T₀/T) of the thicknesses of first portion 411 before and after the compression deformation is defined to set pressure P for applying load F.

The ratio (T₀/T) of the thicknesses of first portion 411 before and after the compression deformation can be calculated using load F in accordance with the Boyle's law as follows: T₀/T=(load F+atmospheric pressure)/atmospheric pressure . . . (Formula 1).

Further, when calculating load F, a temperature change is added to the calculation formula of load F as a parameter of environmental change after battery cell 100 is completed. Specifically, an environmental temperature in the no-load state during assembling of battery cell 100 is assumed to be 25° C., and an environmental temperature after completion of battery cell 100 is assumed to be −30° C. Then, load F can be calculated as follows: load F=the density of the electrode assembly×the thickness of the battery cell× the acceleration of gravity×the acceleration of the vibration/the friction coefficient between the electrode assembly and the case/the number of contact surfaces between the electrode assembly and the case×((273±25° C.)/(273-30° C.)) . . . (Formula 2).

Table 1 shows various conditions such as the density of the electrode assembly, which are assumed to define the ratio of the thicknesses before and after the compression deformation of the elastic body.

TABLE 1

| | Minimum | Maximum |
|---|---|---|
| Density of | 2.1 | 2.6 |
| Electrode | | |
| Assembly [g/cm³] | | |
| Thickness of | 10 | 50 |
| Battery Cell [mm] | | |
| Load [MPa] | 0.030 | 0.187 |
| T₀/T [times] | 1.30 | 2.87 |

The various conditions for battery cell 100 are as shown in Table 1. Load F differs depending on a specification of the battery cell. As shown in Table 1, in the present embodiment, the density of electrode assembly 140 is 2.1 g/cm³ or more and 2.6 g/cm³ or less.

Further, the acceleration of the vibration is assumed to be 12 G. The acceleration of the vibration is set to 12 G in consideration of a safety factor of 1.5 from the maximum acceleration of vibration of 8 G in a vibration characteristic evaluation of the Test of the United Nations Recommendations on Transport of lithium ion batteries (UN Test). Further, a friction coefficient between the electrode assembly and the case is assumed to be 0.05.

Load F can be calculated to be 0.030 MPa or more and 0.187 MPa or less by substituting the density or the like of electrode assembly 140 into Formula 2 described above.

By substituting calculated load F into Formula 1 described above, T₀/T is calculated to be 1.30 or more and 2.87 or less. That is, in the first direction (Y direction), thickness To of first portion 411 in the no-load state is 1.30 times or more and 2.87 times or less as large as thickness T of first portion 411 in the state in which first portion 411 is disposed between the plurality of battery cells 100 and elastically deformed in the compression direction. As a result, appropriate pressure P of closed space 10 is set.

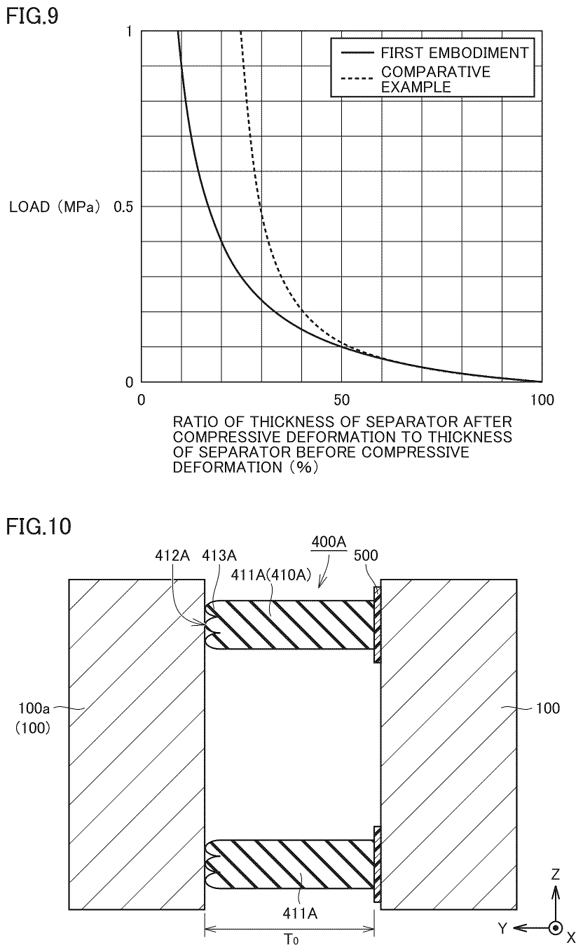

FIG. 9 is a graph showing a relation between the load and the ratio of the thickness of the separator after the compressive deformation to the thickness of the separator before the compressive deformation in the battery module according to each of the first embodiment and a comparative example.

The battery module according to the comparative example is different from the battery module according to the present embodiment in that the separator is a solid elastic body having no closed space. As shown in FIG. 9, when the elastic body is solid, the load for changing the thickness becomes larger as the compression deformation becomes larger, with the result that the elastic body according to the comparative example is less likely to be elastically deformed. Therefore, expansion occurring during use of the battery cell is less likely to be absorbed by the separator. Hence, reaction force of the battery cell applied to the end plate and the restraint member becomes large. Therefore, the end plate and the restraint member need to be strong, thereby causing an increased mass of the battery module, disadvantageously.

On the other hand, in the present embodiment, air is compressed in closed space 11 inside elastic body 410. As compared with the separator according to the comparative example, air can be more readily compressed and deformed than the elastic body, thus resulting in a small load for the compression deformation. Thus, the mass of the battery module can be reduced as described in detail later.

In a method of manufacturing battery module 1 according to the present embodiment, first, separator 400 is prepared. Separator 400 is formed by, for example, injection molding or the like.

Next, the plurality of battery cells 100 are arranged side by side in the first direction (Y direction). Next, adhesive agent layer 500 is applied to one surface of separator 400. Next, separator 400 is disposed between the plurality of battery cells 100. Next, separator 400 is adhered by adhesive agent layer 500 to one of two battery cells 100 between which the separator is to be sandwiched. Thereafter, first portion 411 is elastically deformed by pressing first portion 411 and the end plate in the first direction (Y direction). Thus, separator 400 is compressed and deformed in the first direction (Y direction), thereby completing battery module 1 in which closed space 10 under pressure P is formed.

In battery module 1 according to the first embodiment of the present technology, when separator 400 is formed to include elastic body 410 having first portion 411 having the frame shape and pressure P in closed space 10 inside first portion 411 is used as the reaction force of separator 400 against the expansion of battery cell 100, thickness T of elastic body 410 after the compression deformation in the stacking direction of battery cell 100 is set to be 1.30 times or more and 2.87 times or less in ratio as large as thickness To thereof under application of no load. Thus, it is possible to secure pressure P required to hold the electrode assembly without displacing and damaging the electrode assembly during vibration. Further, as compared with the case where the separator is constituted of a solid elastic body, an increase in load is small even when compressed, thereby suppressing an increase in reaction force even when the battery cell is expanded during the use of the battery cell. As a result, the strength of each of the end plate and the restraint member can be reduced, thereby reducing the mass of each of these members. Further, since required pressure P against the reaction force of battery cell 100 can be obtained in closed space 10 of elastic body 410 by defining, by thickness To in the no-load state, thickness T of elastic body 410 after the compression deformation, separator 400 can be formed to have a simple configuration as compared with a case where the closed space is provided in the separator and the internal pressure of the closed space is adjusted separately by a configuration for adjusting the pressure. As a result, decrease in the reaction force of separator 400 against the expansion of battery cell 100 can be suppressed with such a simple configuration.

In battery module 1 according to the first embodiment of the present technology, since separator 400 can be readily positioned between battery cells 100 by adhering battery cell 100 and elastic body 410 using adhesive agent layer 500, battery module 1 can be readily assembled.

Hereinafter, battery modules according to second to tenth embodiments of the present technology will be described. Since the configuration of the separator in each of the battery modules according to the second to tenth embodiments of the present technology is different from that in battery module 1 according to the first embodiment of the present technology, the same configurations as those of battery module 1 according to the first embodiment of the present technology will not be described repeatedly. It should be noted that in the embodiments described below, a case where the adhesive agent layer is disposed and a case where the adhesive agent layer is not disposed are illustrated, and the adhesive agent layer is not essential. Further, at least one of the states of the separator before and after the compression deformation is illustrated in accordance with the description of each embodiment.

### Second Embodiment

FIG. 10 is a cross sectional view showing a configuration of the battery module according to the second embodiment of the present technology. As shown in FIG. 10, the battery module according to the second embodiment of the present technology includes battery cells 100, end plates, restraint members, a separator 400A, and an adhesive agent layer 500. Separator 400A includes an elastic body 410A.

At a first abutment surface 412A of a first portion 411A of elastic body 410A, first portion 411A is in abutment with at least one battery cell 100a of the plurality of battery cells 100 in the first direction (Y direction). First abutment surface 412A has a protruding-recessed shape.

In the battery module according to the second embodiment of the present technology, by bringing elastic body 410A into abutment with battery cell 100a at a protruding portion of the protruding-recessed shape of first abutment surface 412A so as to attain increased pressure for abutment as compared with a case where they are brought into abutment with each other at a flat surface, it is possible to attain a configuration in which the internal pressure of closed space 11 is less likely to be released to outside from the position of abutment.

### Third Embodiment

FIG. 11 is a cross sectional view showing a configuration of the battery module according to the third embodiment of the present technology. As shown in FIG. 11, the battery module according to the third embodiment of the present technology includes battery cells 100, end plates, restraint members, a separator 400B, a first adhesive agent layer 501B, and a second adhesive agent layer 502B. Separator 400B includes an elastic body 410B.

At a first abutment surface 412B of a first portion 411B of elastic body 410B, first portion 411B is in abutment with at least one battery cell 100a of the plurality of battery cells 100 in the first direction (Y direction). First abutment surface 412B has a protruding-recessed shape.

At an end portion of first portion 411B opposite to the side on which first abutment surface 412B is located, first portion 411B is adhered to the other battery cell 100b of the two battery cells by first adhesive agent layer 501B. First portion 411B is adhered to one battery cell 100a through second adhesive agent layer 502B at first abutment surface 412B.

In the battery module according to the third embodiment of the present technology, by bringing elastic body 410B into abutment with battery cell 100 at a protruding portion of the protruding-recessed shape of first abutment surface 412B so as to attain increased pressure for abutment as compared with a case where they are brought into abutment with each other at a flat surface and by firmly fixing first abutment surface 412B to battery cell 100 by second adhesive agent layer 502B, it is possible to attain a configuration in which the internal pressure of the closed space is less likely to be released to the outside from the position of abutment.

### Fourth Embodiment

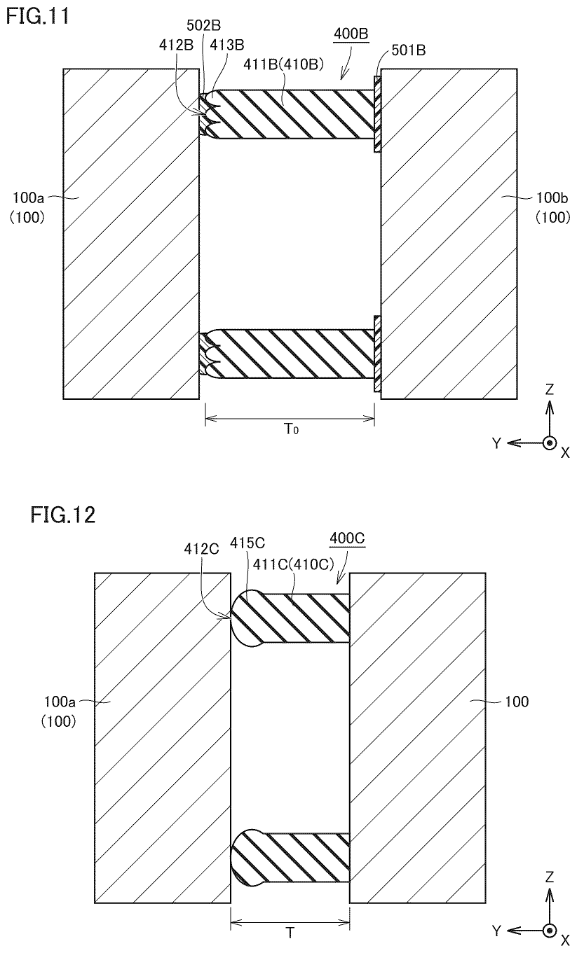

FIG. 12 is a cross sectional view showing a configuration of the battery module according to the fourth embodiment of the present technology. As shown in FIG. 12, the battery module according to the fourth embodiment of the present technology includes battery cells 100, end plates, restraint members, and a separator 400C. Separator 400C includes an elastic body 410C.

At a first abutment surface 412C of a first portion 411C of elastic body 410C, first portion 411C is in abutment with at least one battery cell 100a of the plurality of battery cells 100 in the first direction (Y direction). First abutment surface 412C has a protruding shape.

In the battery module according to the fourth embodiment of the present technology, by bringing elastic body 410C into abutment with battery cell 100 at the protruding shape of first abutment surface 412C so as to attain increased pressure for abutment as compared with a case where they are brought into abutment with each other at a flat surface, it is possible to attain a configuration in which the internal pressure of closed space 11 is less likely to be released to outside from the position of abutment.

### Fifth Embodiment

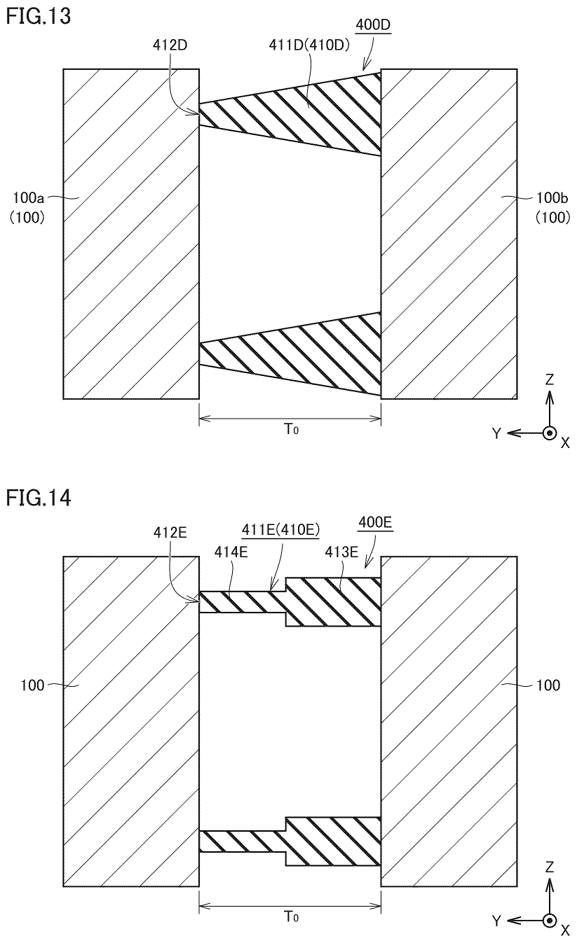

FIG. 13 is a cross sectional view showing a configuration of the battery module according to the fifth embodiment of the present technology. As shown in FIG. 13, the battery module according to the fifth embodiment of the present technology includes battery cells 100, end plates, restraint members, and a separator 400D. Separator 400D includes an elastic body 410D.

At a first abutment surface 412D of a first portion 411D of elastic body 410D, first portion 411D is in abutment with one battery cell 100a of two battery cells 100 between which separator 400D is sandwiched among the plurality of battery cells 100.

The width of first portion 411D becomes narrower in a direction from the other battery cell 100b of the two battery cells toward one battery cell 100a of the two battery cells in the first direction (Y direction).

In the battery module according to the fifth embodiment of the present technology, by narrowing the width of elastic body 410D in the direction from one end portion of elastic body 410D toward the other end portion of elastic body 410D in the first direction (Y direction), it is possible to attain a configuration in which elastic body 410D is readily elastically deformed at the beginning of the elastic deformation and the pressure of the closed space is readily increased.

### Sixth Embodiment

FIG. 14 is a cross sectional view showing a configuration of the battery module according to the sixth embodiment of the present technology. As shown in FIG. 14, the battery module according to the sixth embodiment of the present technology includes battery cells 100, end plates, restraint members, and a separator 400E. Separator 400E includes an elastic body 410E.

First portion 411E of elastic body 410E has a main portion 413E and a thin tip portion 414E. Main portion 413E has a wider width than that of thin tip portion 414E in a direction orthogonal to the first direction (Y direction). It should be noted that the width of first portion 411E may be narrowed in a plurality of stages in a direction from one side of first portion 411E toward the other side of first portion 411E in the first direction (Y direction).

In the battery module according to the sixth embodiment of the present technology, since first portion 411E has thin tip portion 414E having a width narrower than that of main portion 413E, it is possible to attain a configuration in which elastic body 410E is readily elastically deformed at the beginning of elastic deformation and the pressure of the closed space is readily increased.

### Seventh Embodiment

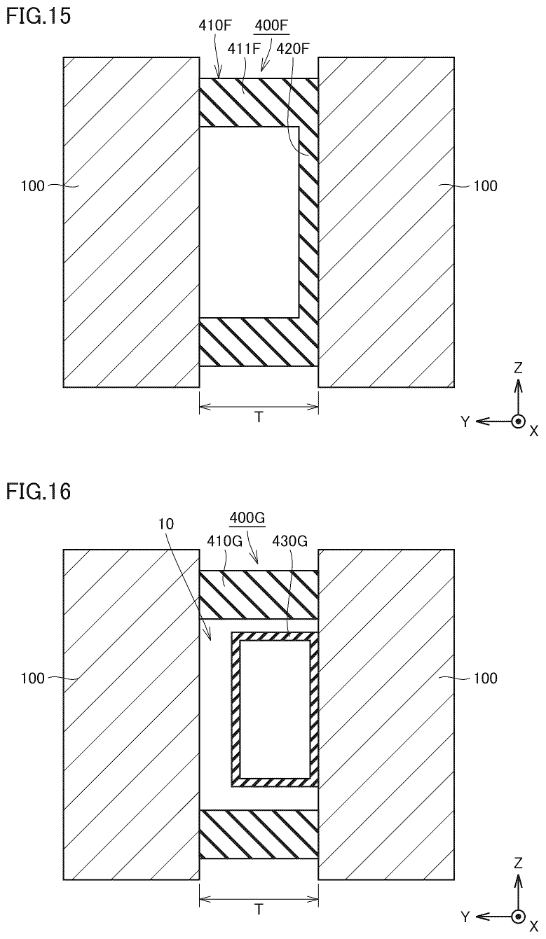

FIG. 15 is a cross sectional view showing a configuration of a battery module according to a seventh embodiment of the present technology. As shown in FIG. 15, the battery module according to the seventh embodiment of the present technology includes battery cells 100, end plates, restraint members, and a separator 400F. Separator 400F includes an elastic body 410F.

Elastic body 410F has a first portion 411F and a connection portion 420F. Connection portion 420F is located at an end portion of first portion 411F in the first direction (Y direction). In the present embodiment, connection portion 420F is in abutment with battery cell 100.

Connection portion 420F connects the peripheral edges of the frame shape of first portion 411F. In the present embodiment, connection portion 420F connects the peripheral edges of the frame shape of first portion 411F entirely. It should be noted that connection portion 420F is not limited to this configuration. Connection portion 420F may have, for example, a mesh shape or the like when viewed in the first direction (Y direction) so as to connect the peripheral edges of the frame shape partially.

In the battery module according to the seventh embodiment of the present technology, since the peripheral edges of the frame shape of first portion 411F are connected by connection portion 420F, the frame shape of first portion 411F is less likely to be deformed when disposing separator 400 between battery cells 100 with separator 400 being grasped or the like, with the result that separator 400 can be readily handled.

### Eighth Embodiment

FIG. 16 is a cross sectional view showing a configuration of the battery module according to the eighth embodiment of the present technology. As shown in FIG. 16, the battery module according to the eighth embodiment of the present technology includes battery cells 100, end plates, restraint members, and a separator 400G. Separator 400G includes an elastic body 410G and a heat insulating material 430G.

Heat insulating material 430G is disposed in closed space 10 of elastic body 410G. Heat insulating material 430G includes air therein to exhibit a high heat insulating function. Heat insulating material 430G is composed of, for example, a porous body, glass fiber, or the like. It should be noted that heat insulating material 430G may be formed to include an inorganic filler (for example, a ceramic such as alumina) and a polymer material.

In the battery module according to the eighth embodiment of the present technology, since heat insulating material 430G is disposed in closed space 10 of elastic body 410G, separator 400G can be provided with the reaction force against battery cell 100 and the heat insulation function without increasing the thickness of separator 400G as compared with a case where elastic body 410G and heat insulating material 430G are disposed to overlap with each other in the first direction (Y direction).

### Ninth Embodiment

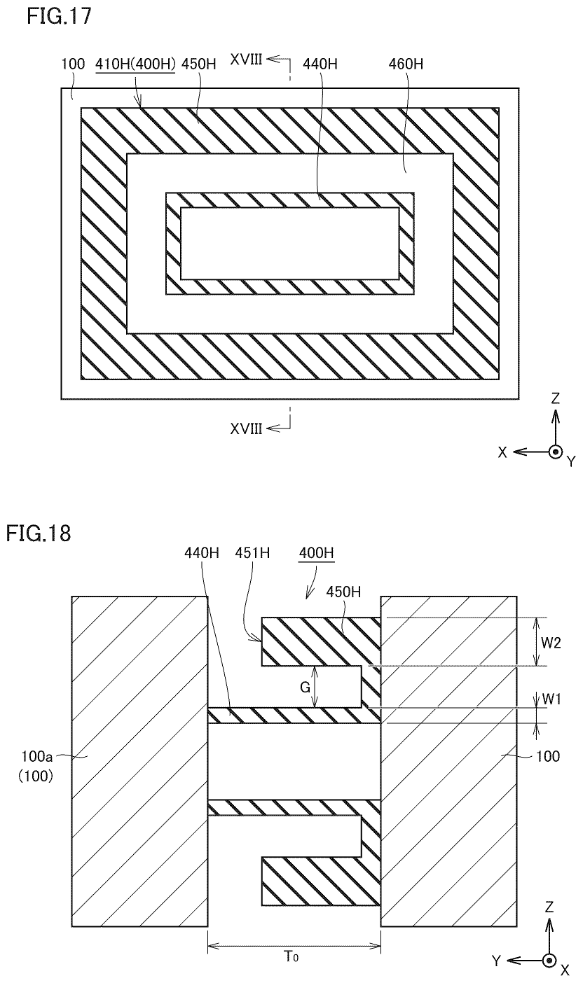

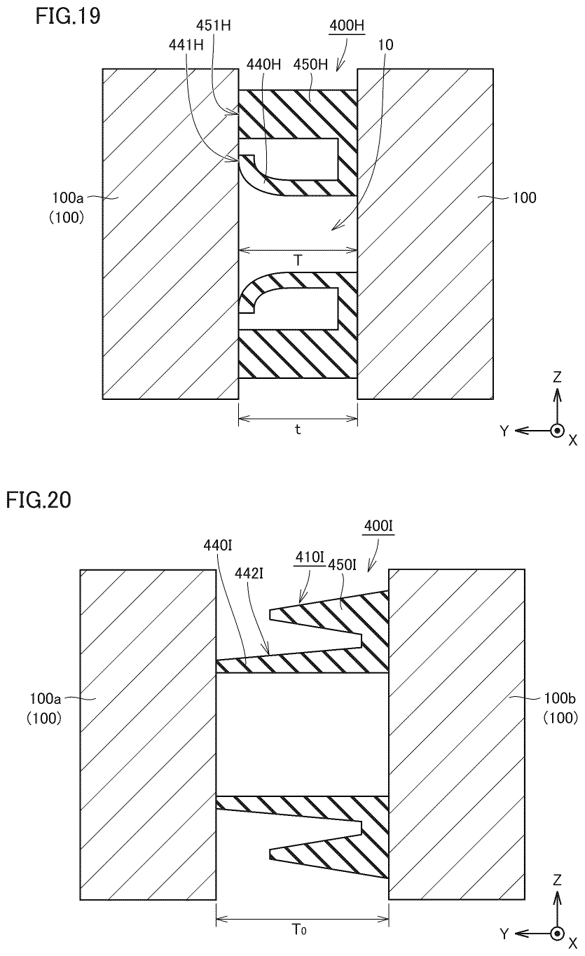

FIG. 17 is a cross sectional view showing a configuration of the battery module according to the ninth embodiment of the present technology when the separator is in a no-load state. FIG. 18 is a cross sectional view of the battery module of FIG. 17 when viewed in a direction of arrows of a line XVIII-XVIII. FIG. 19 is a cross sectional view showing a configuration of the battery module according to the ninth embodiment of the present technology in a state in which the separator is compressed and deformed.

As shown in FIGS. 17 to 19, the battery module according to the ninth embodiment of the present technology includes battery cells 100, end plates, restraint members, and a separator 400H. Separator 400H includes an elastic body 410H.

Elastic body 410H has a first portion 440H and a second portion 450H. At a first abutment surface 441H of first portion 440H, first portion 440H is in abutment with at least one battery cell 100a of the plurality of battery cells 100 in the first direction (Y direction).

Second portion 450H is located on an outer side with respect to first portion 440H when viewed in the first direction (Y direction), and has a frame shape extending around the axis in the first direction (Y direction).

At a second abutment surface 451H of second portion 450H, second portion 450H is in abutment with at least one battery cell 100a of the plurality of battery cells 100 in the first direction (Y direction).

A clearance G is provided between first portion 440H and second portion 450H in a direction orthogonal to the first direction (Y direction). In the present embodiment, clearance G is provided entirely around the axis in the first direction (Y direction) between first portion 440H and second portion 450H.

At an end portion of first portion 440H opposite to a side on which first abutment surface 441H is located in the first direction (Y direction), first portion 440H has a first width W1 of a portion of the frame shape of first portion 440H in the direction orthogonal to the first direction.

At an end portion of second portion 450H opposite to the side on which second abutment surface 451H is located in the first direction (Y direction), second portion 450H has a second width W2 of a portion of the frame shape of second portion 450H in the direction orthogonal to the first direction. Second width W2 is wider than first width W1.

As shown in FIG. 19, in the first direction (Y direction), thickness t of second portion 450H in a state in which second portion 450H is in abutment with at least one battery cell 100 is substantially the same as thickness T of first portion 440H in a state in which first portion 440H is disposed between the plurality of battery cells 100 and is elastically deformed in the compression direction.

In the battery module according to the ninth embodiment of the present technology, since elastic body 410H has first portion 440H and second portion 450H, closed space 10 can be defined by first portion 440H and battery cell 100 can be supported by second portion 450H.

In the battery module according to the ninth embodiment of the present technology, since clearance G is provided between first portion 440H and second portion 450H, first portion 440H is less likely to interfere with second portion 450H when first portion 440H is collapsed to the second portion 450H side during the compressive deformation of elastic body 410H.

In the battery module according to the ninth embodiment of the present technology, since second width W2 of the second portion is wider than first width W1 of first portion 440H, first portion 440H for closing the inside of elastic body 410H is readily deformed and second portion 450H for maintaining the compressed pressure is less likely to be collapsed, with the result that the pressure of closed space 10 of elastic body 410H can be readily secured.

### Tenth Embodiment

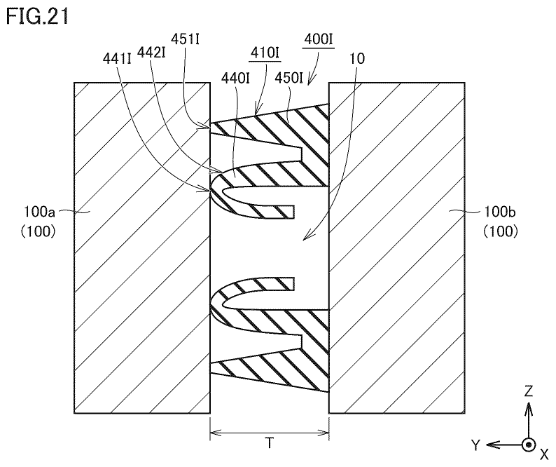

FIG. 20 is a cross sectional view showing a configuration of the battery module according to the tenth embodiment of the present technology when the separator is in the no-load state. FIG. 21 is a cross sectional view showing a configuration of the battery module according to the tenth embodiment of the present technology in a state in which the separator is compressed and deformed.

As shown in FIGS. 20 and 21, the battery module according to the tenth embodiment of the present technology includes battery cells 100, end plates, restraint members, and a separator 400I. Separator 400I includes an elastic body 410I.

Elastic body 410I has a first portion 440I and a second portion 450I. At a first abutment surface 441I of first portion 440I, first portion 440I is in abutment with one battery cell 100a of two battery cells 100 between which separator 400I is sandwiched among the plurality of battery cells 100 in the first direction (Y direction).

Second portion 450I is located on an outer side with respect to first portion 440I when viewed in the first direction (Y direction), and has a frame shape extending around the axis in the first direction (Y direction).

At a second abutment surface 451I of second portion 450I, second portion 450I is in abutment with at least one battery cell 100a of the plurality of battery cells 100 in the first direction (Y direction).

First portion 440I has a tapered surface 442I. Tapered surface 442I faces second portion 450I and is inclined, in a direction from the other battery cell 100b toward one battery cell 100a of the plurality of battery cells 100, from the outer side toward the inner side around the axis in the first direction (Y direction) in the no-load state. When a load is applied to first portion 440I, the load is obliquely applied and therefore first portion 440I is likely to be collapsed to the inner side.

In the battery module according to the tenth embodiment of the present technology, since tapered surface 442I is provided in first portion 440I on the side facing second portion 450I, first portion 440I can be likely to be collapsed to the inner side when elastic body 410I is compressed and deformed, with the result that it is possible to attain a configuration in which first portion 440I and second portion 450I are less likely to interfere with each other.

It should be noted that in each of the embodiments, the separator disposed between the plurality of battery cells has been described; however, the same configuration as that of the above-described separator can be applied to the separator disposed between the battery cell and the end plate. Further, in the present specification, the expression “the same size” means that the sizes of the design values are the same with no manufacturing tolerance being included.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A battery module comprising:
a plurality of battery cells arranged side by side in a first direction; and
a separator located between the plurality of battery cells, wherein
the separator includes an elastic body that is elastically deformable at least in the first direction,
the elastic body has a first portion having a frame shape that extends around an axis in the first direction and that defines a closed space inside the first portion, and
in the first direction, a thickness of the first portion in a no-load state is 1.30 times or more and 2.87 times or less as large as a thickness of the first portion in a state in which the first portion is disposed between the plurality of battery cells and is elastically deformed in a compression direction.

2. The battery module according to claim 1, wherein
at a first abutment surface of the first portion, the first portion is in abutment with at least one battery cell of the plurality of battery cells in the first direction, and
the first abutment surface has a protruding-recessed shape.

3. The battery module according to claim 2, wherein
at the first abutment surface, the first portion is in abutment with one battery cell of two battery cells between which the separator is sandwiched among the plurality of battery cells, and
in the first direction, a width of the first portion becomes narrower in a direction from the other battery cell of the two battery cells toward the one battery cell of the two battery cells.

4. The battery module according to claim 1, wherein the elastic body further has a connection portion that is located at an end portion of the first portion in the first direction and that connects peripheral edges of the frame shape of the first portion.

5. The battery module according to claim 2, wherein the elastic body further has a connection portion that is located at an end portion of the first portion in the first direction and that connects peripheral edges of the frame shape of the first portion.

6. The battery module according to claim 3, wherein the elastic body further has a connection portion that is located at an end portion of the first portion in the first direction and that connects peripheral edges of the frame shape of the first portion.

7. The battery module according to claim 1, wherein
the elastic body further has a second portion that is located on an outer side with respect to the first portion when viewed in the first direction and that has a frame shape extending around the axis in the first direction,
at a second abutment surface of the second portion, the second portion is in abutment with at least one battery cell of the plurality of battery cells in the first direction, and
in the first direction, a thickness of the second portion in a state in which the second portion is in abutment with the at least one battery cell is substantially the same as the thickness of the first portion in the state in which the first portion is disposed between the plurality of battery cells and is elastically deformed in the compression direction.

8. The battery module according to claim 2, wherein
the elastic body further has a second portion that is located on an outer side with respect to the first portion when viewed in the first direction and that has a frame shape extending around the axis in the first direction,
at a second abutment surface of the second portion, the second portion is in abutment with at least one battery cell of the plurality of battery cells in the first direction, and
in the first direction, a thickness of the second portion in a state in which the second portion is in abutment with the at least one battery cell is substantially the same as the thickness of the first portion in the state in which the first portion is disposed between the plurality of battery cells and is elastically deformed in the compression direction.

9. The battery module according to claim 7, wherein a clearance is formed between the first portion and the second portion in a direction orthogonal to the first direction.

10. The battery module according to claim 8, wherein a clearance is formed between the first portion and the second portion in a direction orthogonal to the first direction.

11. The battery module according to claim 1, wherein
the elastic body further has a second portion that is located on an outer side with respect to the first portion when viewed in the first direction and that has a frame shape extending around the axis in the first direction,
at a first abutment surface of the first portion, the first portion is in abutment with at least one battery cell of the plurality of battery cells in the first direction,
at a second abutment surface of the second portion, the second portion is in abutment with the at least one battery cell in the first direction,
at an end portion of the first portion opposite to a side on which the first abutment surface is located in the first direction, the first portion has a first width of a portion of the frame shape of the first portion in a direction orthogonal to the first direction,
at an end portion of the second portion opposite to a side on which the second abutment surface is located in the first direction, the second portion has a second width of a portion of the frame shape of the second portion in the direction orthogonal to the first direction, and
the second width is wider than the first width.

12. The battery module according to claim 1, wherein
the elastic body further has a second portion that is located on an outer side with respect to the first portion when viewed in the first direction and that has a frame shape extending around the axis in the first direction,
at a first abutment surface of the first portion, the first portion is in abutment with one battery cell of two battery cells between which the separator is sandwiched among the plurality of battery cells, and
the first portion has a tapered surface that faces the second portion and that is inclined, in a direction from the other battery cell of the plurality of battery cells toward the one battery cell of the plurality of battery cells, from the outer side toward an inner side around the axis in the first direction in the no-load state.

13. The battery module according to claim 1, wherein the separator further includes a heat insulating material disposed in the closed space and having an inner space.

14. The battery module according to claim 2, wherein the separator further includes a heat insulating material disposed in the closed space and having an inner space.

15. The battery module according to claim 1, further comprising an adhesive agent layer that adheres the elastic body and the plurality of battery cells in the first direction.

16. The battery module according to claim 2, further comprising an adhesive agent layer that adheres the elastic body and the plurality of battery cells in the first direction.
